(19) United States
(12) Patent Application Publication
(10) Pub. No.: US 2015/0149380 A1
(43) Pub. Date: May 28, 2015

(54) Method and System for College Matching

(71) Applicants: Saagar Sunil Kulkarni, Springboro, OH (US); Maansi Sunil Kulkarni, Springboro, OH (US)

(72) Inventors: Saagar Sunil Kulkarni, Springboro, OH (US); Maansi Sunil Kulkarni, Springboro, OH (US)

(21) Appl. No.: 14/550,951

(22) Filed: Nov. 22, 2014

Related U.S. Application Data
(60) Provisional application No. 61/908,098, filed on Nov. 23, 2013.

(51) Int. Cl. G06Q 10/10

(52) U.S. Cl. CPC G06Q 10/10; G06Q 50/2053
USPC 705/327

(57) ABSTRACT

The present invention generally related to a system and method for selecting a college wherein student providing individual input such as GPA, SAT, and or ACT scores, further from there it is compared to the average student accepted into a particular college, after compared, the student is given a report based on how their scores match up with all the colleges based on the college ranking model, for the Graduate program SAT and ACT scores will be replaced by GRE, MCAT, GMAT, and LSAT for Engineering/Sciences/Education, Medicine, Business, and Law respectively.

### CROSS REFERENCE TO RELATED APPLICATION

The instant application claims priority to the U.S. Provisional Application No. 61/908,098 filed on Nov. 23, 2013, which is incorporated by reference herein.

### FIELD OF THE INVENTION

The present invention generally related to computer-based college matching advisor system and method more particularly to a computer based algorithms and software enabling making certain college matching decisions.

### BACKGROUND OF THE INVENTION

Currently, we are faced with the problem of having access to a mass amount of information. When people search for pertinent and useful facts online, they are flooded with a myriad of results. This problem especially arises when high school students are looking toward their futures and the colleges they would like to attend. When students begin their research on certain colleges, they tend to become blind-sided by a multitude of numbers, scores, etc. that they must attain to get those desired acceptance letters. In turn, the college search becomes a dreaded and scattered hunt for information. Given that the majority of people do not possess a photographic memory, students are constantly hassled with the task of visiting college websites for the scores they need to get into college.

There exists on line services such as Naviance.com^{[1]}, USNews.com^{[2]}, and CollegeBoard.org that collectively offer college ranking, average student GPA and standardized test results, acceptance rates, financial information, incoming class size, and other important relevant statistical information. Applying to college also poses another question: Will a student be accepted into the colleges to which he/she apply? The College Board, Naviance, U.S. News, and every college website provide historical averages of previous students that they have accepted. However, with all the numbers, including SAT, ACT, and GPA, is there a certain mathematical equation purely based on academics that can match a student with the top colleges that suit them the best? There is a serious gap between having the information and comparing different colleges to see how one fits among the best. However, this approach will be truly quantitative. The test scores do not solely determine acceptance into a college. A typical college admission committee always takes a holistic approach to determine if a student is suited for attending their school, which includes looking at recommendation letters, essays, extracurricular activities, and many other qualitative factors that cannot be expressed by numbers in addition to GPA and standardized test scores. There will always a degree of uncertainty that comes along with the application process. Otherwise computers could just crunch numbers and base acceptance solely on the numbers that a student submits. Whether information students provide should be quantitative or qualitative is not the problem that needs to be addressed. Instead, the question becomes: Is there a way to decipher which colleges are the match for a student by taking the uncertainty out of the quantitative information that they provide? Once the student has this answer then he/she can make sure that his/her qualitative record is in good shape to be accepted into their dream college. However, it is often found that such tools are either non- specific in recommendations on one hand or too complex requiring multitude of inputs on the other. A non-specific college matching advisor tool often gives a generic response as an output showing average student information or range for students accepted in a certain percentile range. On the other hand, too complex input and output based systems require multitude of inputs. The output consisting of generic college information prompts more questions than the answer. Certain other conventional college advising tools, often called as “college screeners” or “college ranking lists” provide for searching for colleges which match certain student specified criteria such as state of residence, major, how far you want to move away from home, etc. However, these tools often provide mere listing of colleges and do not tell the student how the college selects based on academic scores. They thus fall short of providing concrete college matching advice.

### SUMMARY OF INVENTION

Main object of the present invention is to provide a method and system for providing concrete college matching advice.

Yet another object of the present invention is to provide a method and system computer based on algorithms and software enabling making certain college matching decisions.

It is an object of the present invention to overcome drawbacks and limitations of conventional methodologies or techniques for providing college advisor systems and methods.

### BRIEF DESCRIPTION OF DRAWINGS

Embodiments of the present invention are illustrated in the figures of the accompanying drawings. These figures are exemplary and they should not unduly limit the scope of the invention.

FIG. 1 is a college matching flow chart illustrating an exemplary schematic of a system for advising according to a specific embodiment of the present invention.

FIGS. 2 to 10 illustrate several exemplary schematic of a system for college advising according to a specific embodiment of the present invention.

FIG. 11 illustrates an exemplary computer network system that can provide an environment to practice the present invention according to a specific embodiment.

FIG. 12 illustrates an exemplary computer apparatus that can provide a computing platform to practice the present invention in accordance with a specific embodiment of the present invention.

FIGS. 13-17 illustrate several exemplary computer screenshots for receiving student input according to a specific embodiment of the present invention.

### DETAILED DESCRIPTION OF THE PRESENT INVENTION

The Figures are provided to aid thorough disclosure of the invention. Based on the present disclosure, person of ordinary skill in the art can contemplate various alternatives, variations and modifications to the illustrated embodiments within the scope of the invention disclosed herein.

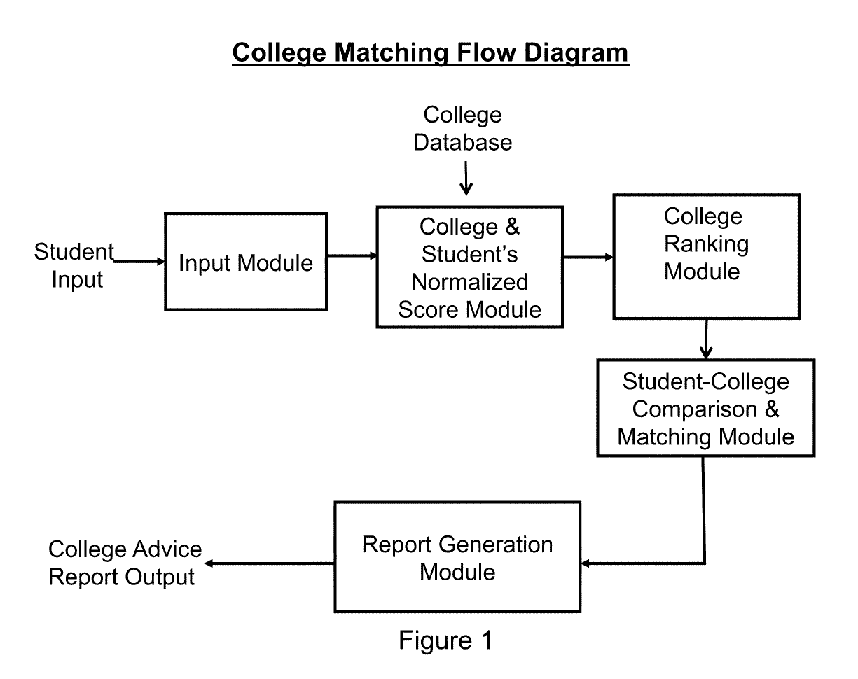

As shown in FIG. 1 it displays a flow chart of the step-by-step process of the website. First, the high school student puts in his/her individual input (GPA, SAT, and or ACT scores) and from there it is compared to the average student's information accepted into a particular college. Once compared, the student is given a report based on how their scores match up with all the colleges (using the college ranking model). For the Graduate program SAT and ACT scores will be replaced by GRE, MCAT, GMAT, and LSAT for Engineering/Sciences/Education, Medicine, Business, and Law respectively.

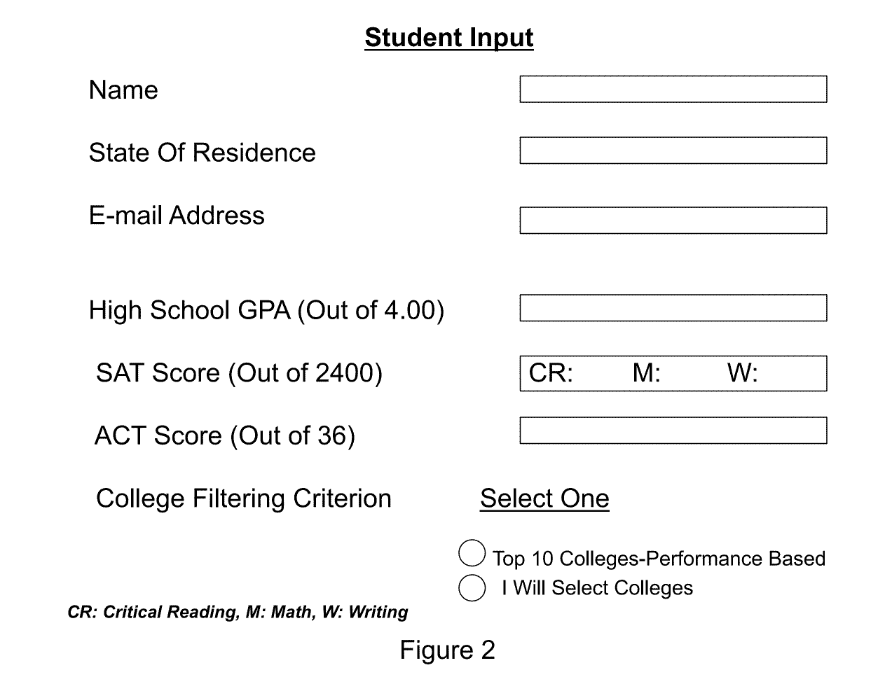

FIG. 2 is a template of the personal information a student must fill out to use the college matching system. The state of residence information is used in order to determine the in state versus out of state tuition for the student. There is also two college filtering criterion that a student can select: “Top 10 Colleges-Performance Based” or “I Will Select Colleges.” When “Top 10 Colleges-Performance Based” choice is selected, the system will find colleges at or just below the overall academic score of the student. This academic score is based on a weighted average of the GPA and the standardized test scores. The second option, “I Will Select Colleges” allows the student to select colleges of his or her choosing from an alphabetical list of colleges. The algorithm will color code whether a student is a good match or not based on an academic basis. In ‘Top 10,’ 10 is a number used for illustrative purposes and 10 can be replaced by any non-zero integer number (e.g. 1, 5, 22, etc.).

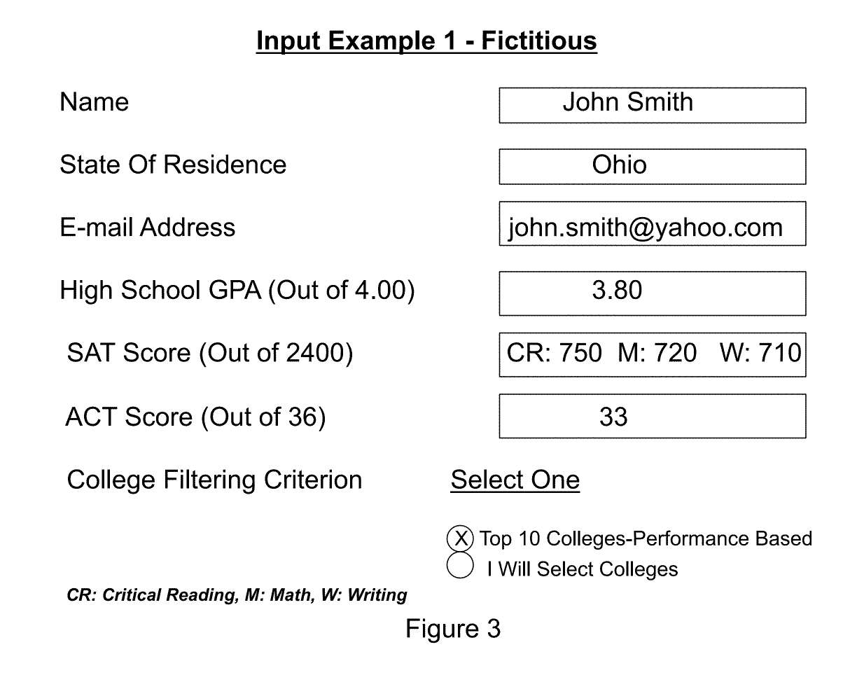

From quantitative academic information, like GPA and standardized test scores, a number can be calculated to represent a student's scores. Every college, for their average accepted student's quantitative scores, will be assigned a calculated normalized score number. Essentially a match between a student's number and a college's number is found. This number is calculated by taking a simple weighted average. The weights summation will be one. The examples in FIGS. 3 through 10 assume only two weights (w₁, w₂) and considers two variables when calculating this weighted average. The approach can be modified with different number of weights to consider just one variable, two variables, three or more variables, etc. The parameters can be quantitative (GPA, SAT scores, ACT scores, any other test scores) or letters (e.g. letter grades, ‘A’ through ‘F’ instead of GPA or ‘J’ through ‘T’ for MCAT writing and any other letter scores) or combination of quantitative and qualitative scores and grades.

For example using two variable approach such as students that have only taken one of the standardized tests or both and SAT viewed out of 1600 (Critical Reading and Math) or 2400 (Critical Reading, Math, and Writing), since some colleges look at scores out of 1600 while others out of 2400.

FIG. 3 shows a fictitious example of a student who has taken both the SAT and ACT test and has selected the “Top 10 Colleges-Performance Based” as his college filtering criterion.

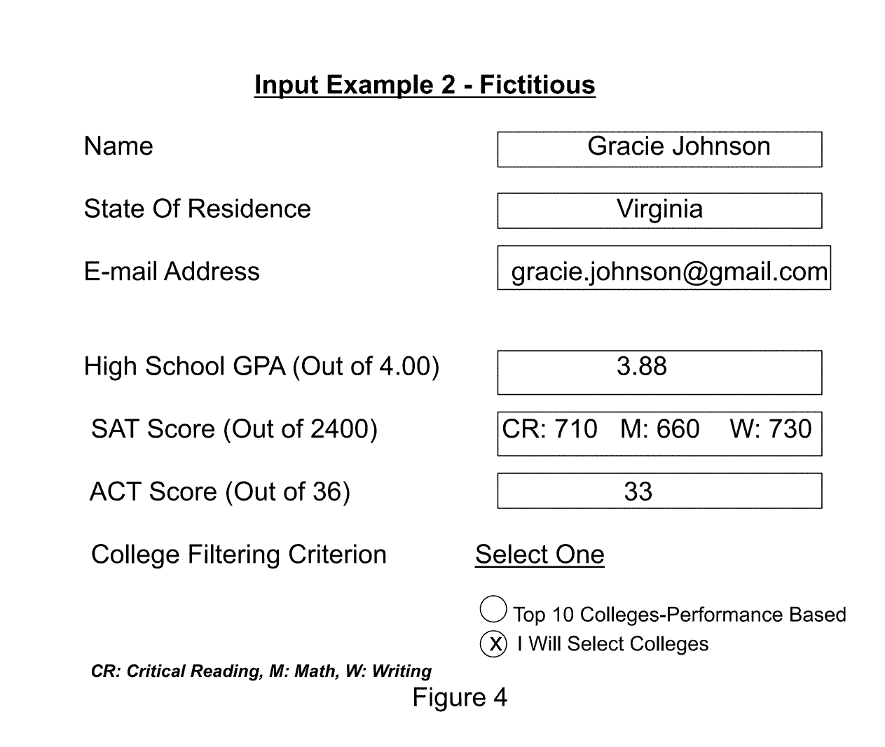

FIG. 4 shows another fictitious example of a student who has taken both the SAT and ACT test and wants to select colleges from the alphabetical list of colleges.

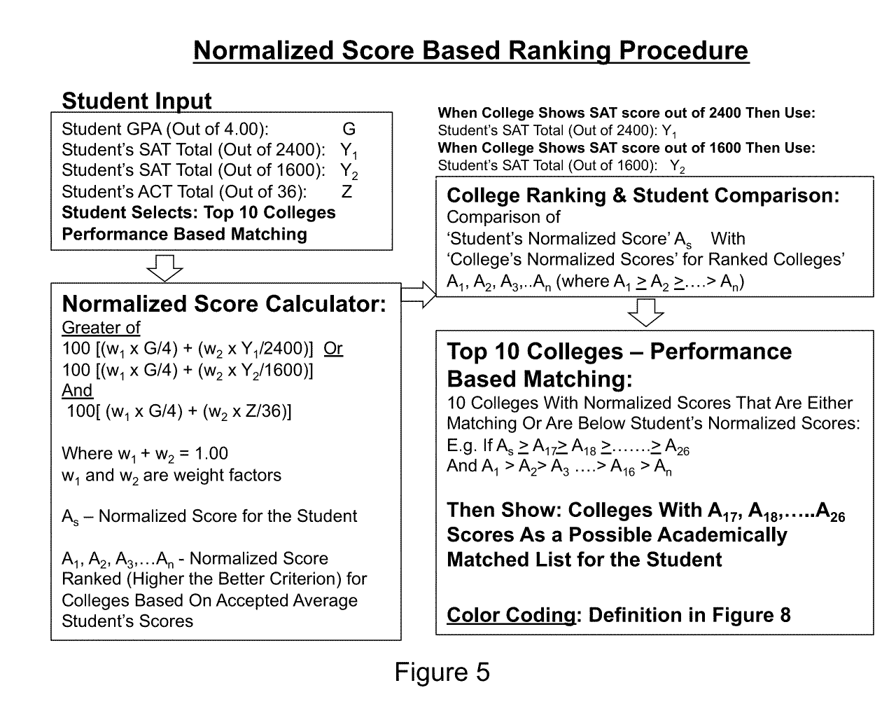

FIG. 5 contains variables G, Y₁, Y₂, and Z, which are defined as:
Student GPA (Out of 4.00): G
SAT Total (Out of 2400): Y₁
SAT Total (Out of 1600): Y₂
ACT Total (Out of 36): Z

For example the normalized score is a weighted average of the GPA and one or more of the SAT and the ACT score. Some colleges use the SAT scores for all three sections (Critical Reading, Math, Writing, totaling 2400), while others only take into account two sections (Critical Reading and Math, Totaling 1600). When colleges use SAT scores out of 2400 the system will use Y₁ for comparison purposes. When colleges use SAT scores out of 1600 the system will use Y₂ for comparison. The normalized score for the student takes into consideration whether the student has taken the SAT or ACT test and whether the college's criterion for the SAT is either 1600 based or 2400 based. If the student has taken both standardized tests, the bigger normalized score of the two tests will be compared with the college's normalized score based off of that particular standardized test. If the student has taken both standardized tests and the normalized score using SAT is bigger than using ACT, then the student's SAT based normalized score will be compared with the college's average accepted student's SAT based normalized score. For each college, the normalized score for the average accepted student is estimated based off of both SAT and ACT test scores. The colleges are then ranked by a decreasing normalized score (A₁, A₂, A₃, . . . Aₙ.) When the student has chosen the “Top 10 Colleges Performance-Based Matching,” then the student's normalized score Aₛ is compared to the ranked college's normalized score. For example, if Aₛ is greater than or equal to A₁₇ then the system will display colleges A₁₇≧ A₁₈≧ . . . ≧ A₂₆ as the top 10 colleges for the student.

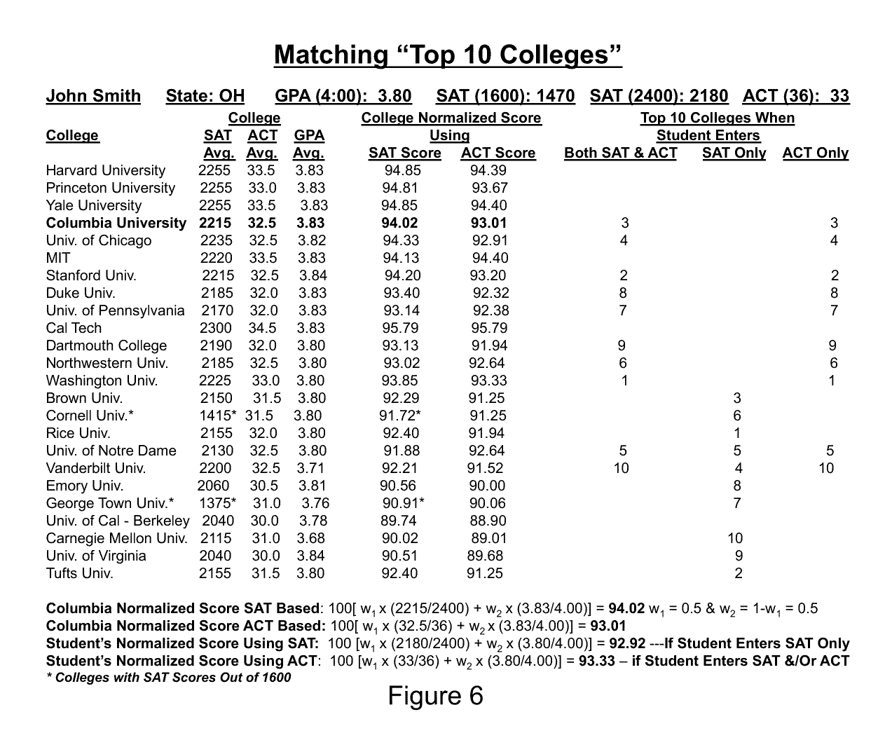

FIG. 6 shows the ranking for where the student from FIG. 3 will best fit in from academic scores standpoint. The student's normalized score based on the SAT is 92.92, while that of the ACT's is 93.33. If the student had only entered SAT scores as the input, then the student's score of 92.92 will be used to determine the Top 10 colleges (performance based). The student's score of 93.33 will be used if the student had only entered his ACT score. However, if the student entered both his SAT and ACT scores then the ACT based score will be used as the normalized score because it is the higher of the normalized scores for the student.

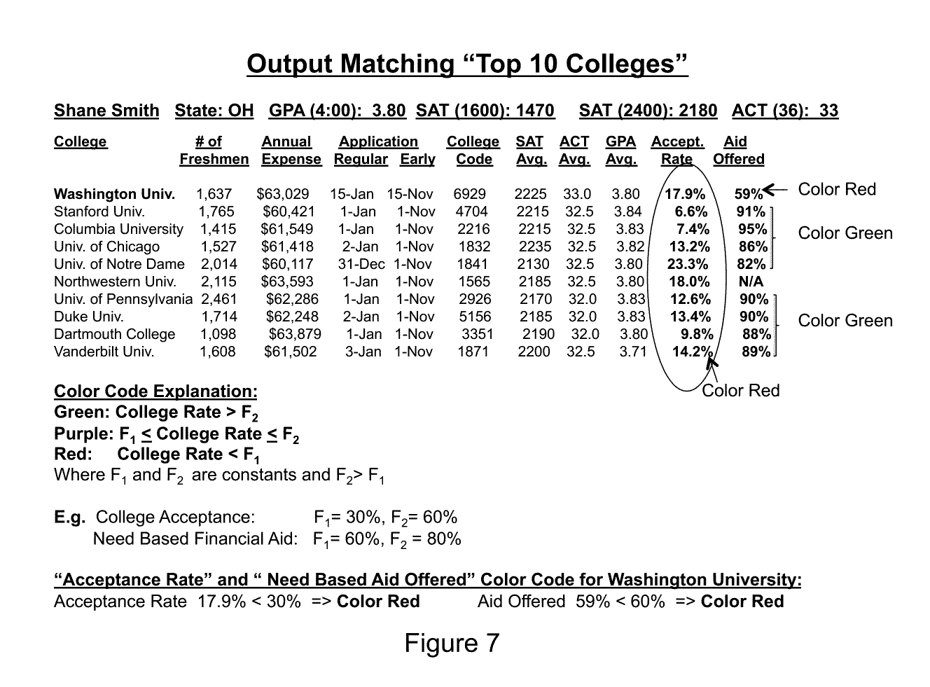

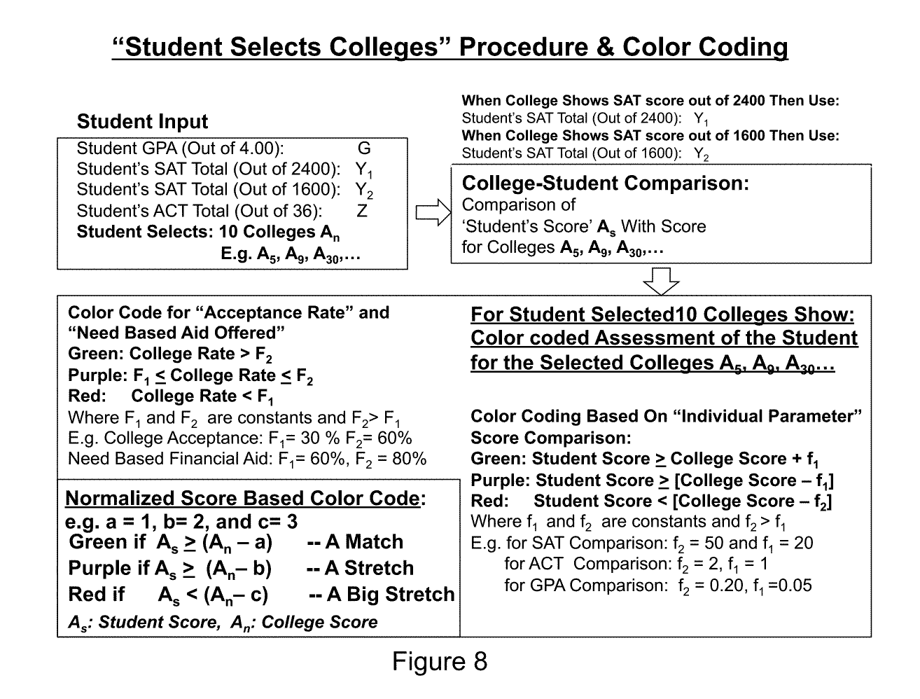

FIG. 7 shows the top 10 colleges for the student from FIG. 3. The following is an example for information that will be provided to the student in an output report: website URL for the institution, size of entering class, annual expense, application deadlines, college average student's academic information, college acceptance rate, percentage of students receiving financial aid, and also admission official's e-mail/address/phone number, majors offered, ranking for majors of interest, and any other pertinent college information. The color codes have also been assigned to show decreasing ease of acceptance (green, purple, and red). The color coding approach is defined in FIG. 8. “Color Coding’ is one approach to distinguish between thresholds for parameters and they can be replaced by other approaches such as different color letters, bold letters, italic letters, underlined words, etc.

FIG. 8 shows the process of student selecting, “I Will Select Colleges” as an option. The student can select ten colleges from an alphabetical list of colleges wherein ten is used as an Example—it can be any positive integer number. One or more thresholds can be used for the threshold numbers. F₁ and F₂ are subjective for the acceptance rate and financial aid offered while the threshold numbers f₁ and f₂ take into consideration statistical distribution for accepted students for GPA and standardized test results at colleges. The color coding using f₁ and f₂ is defined for ‘individual parameter” comparison between the student and an accepted average student at a college. Also, the figure describes the definition of “A Match,” “A Stretch,” and “A Big Stretch” using Green, Purple, Red respectively for comparison of the student's normalized score Aₛ and the college normalized score Aₙ. ‘A Match,’ ‘A Stretch,’ and ‘A Big Stretch’ are examples and can be replaced by similar words used for comparison. E.g. ‘Likely to get in,’ ‘A Good Chance to get in,’ ‘A Long Shot to get in,’ etc.

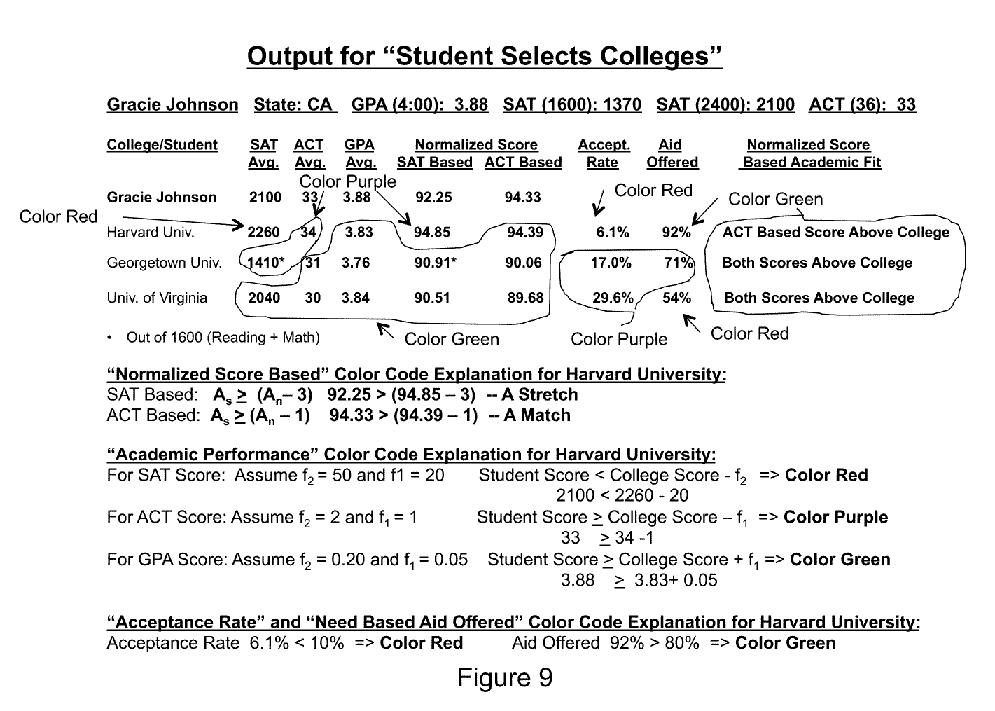

FIG. 9 shows an example of the student from FIG. 4. The text appears in Purple if the student is within the range of the average accepted student's performance. Green indicates that the student is above the threshold of the average accepted student. Red indicates that the student is below the threshold of the average accepted student. The low acceptance rates (e.g. below 10%) and financial aid offered (e.g. below 60%) is also shown in red.

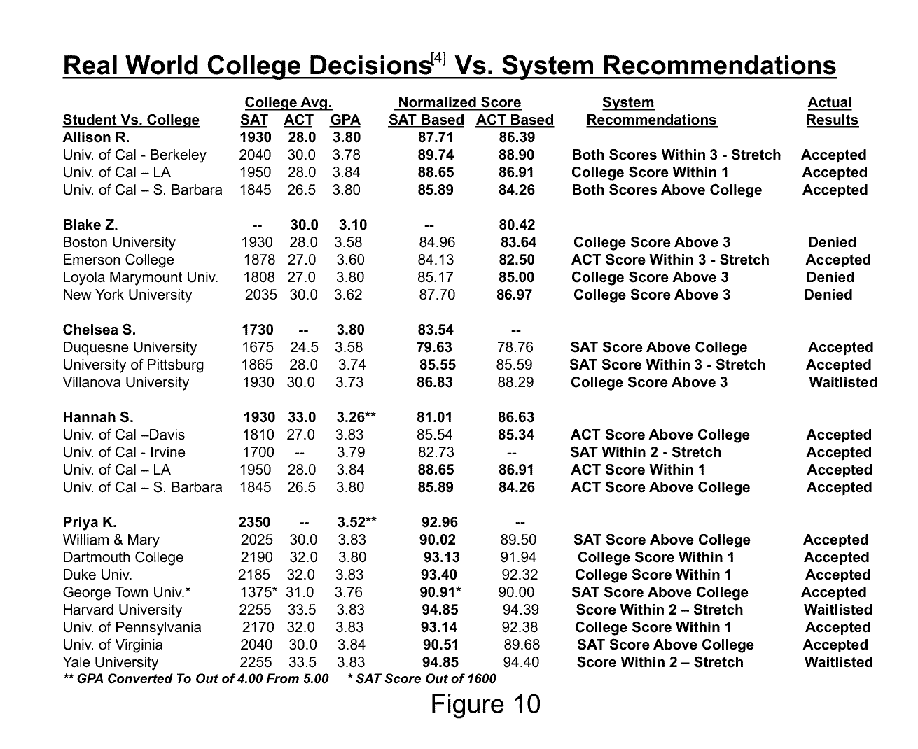

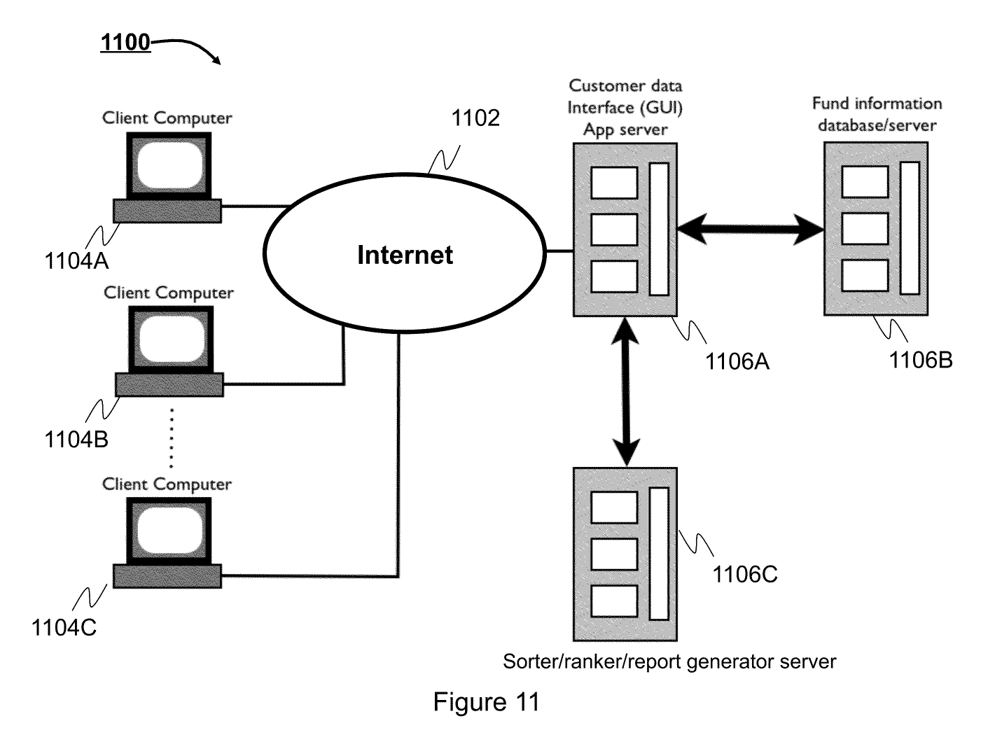

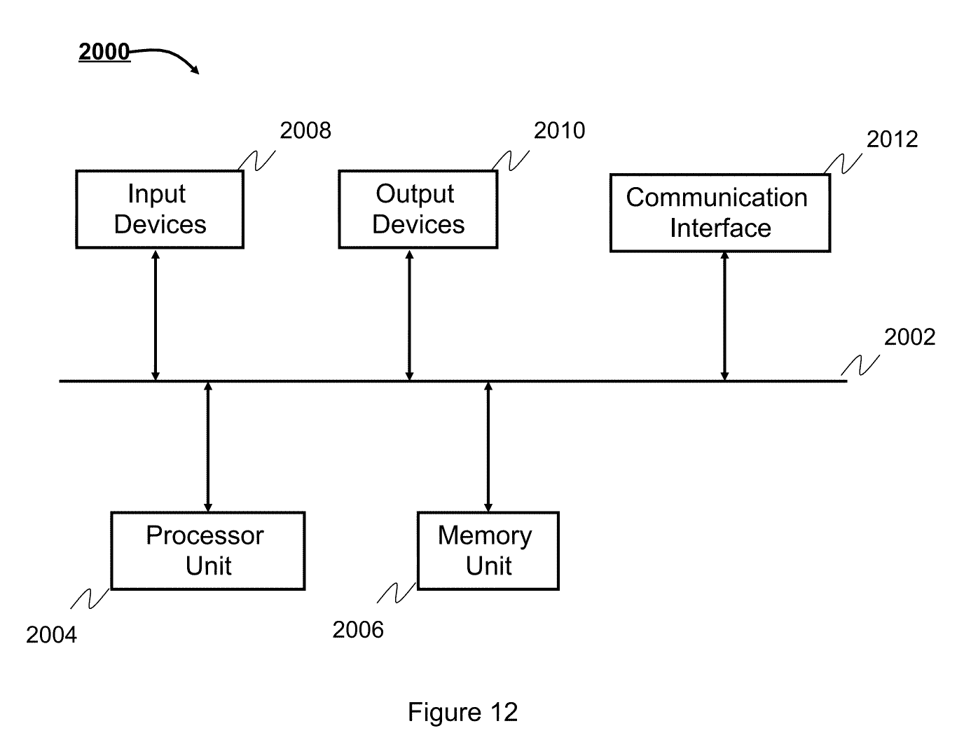

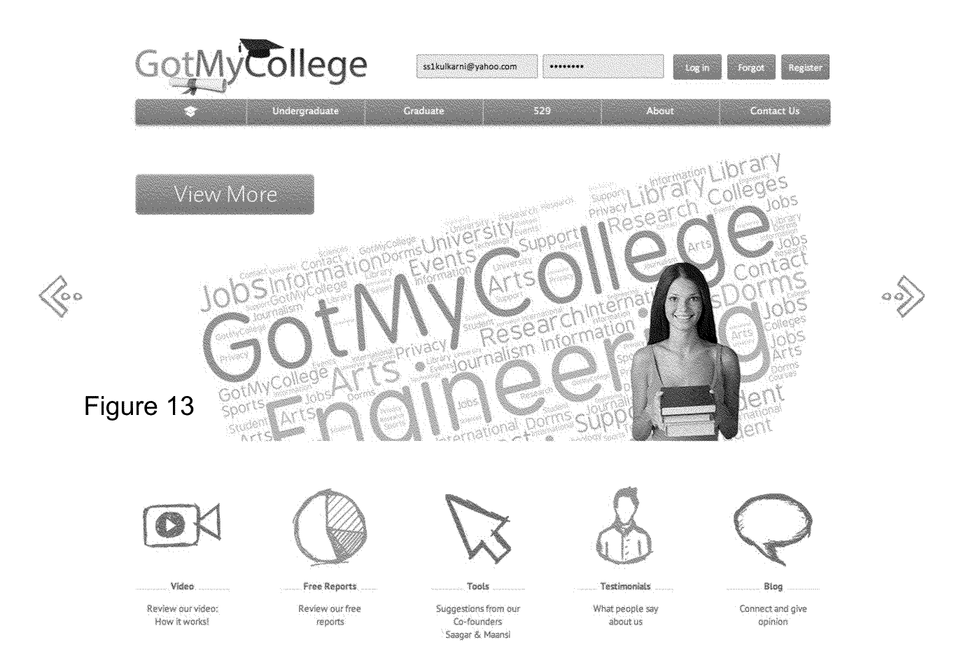

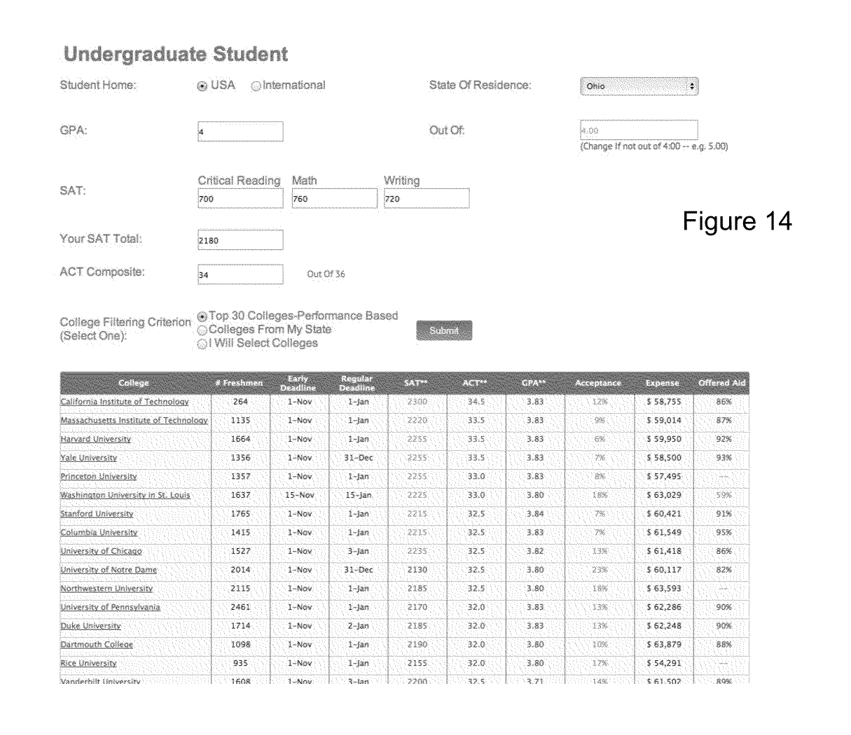

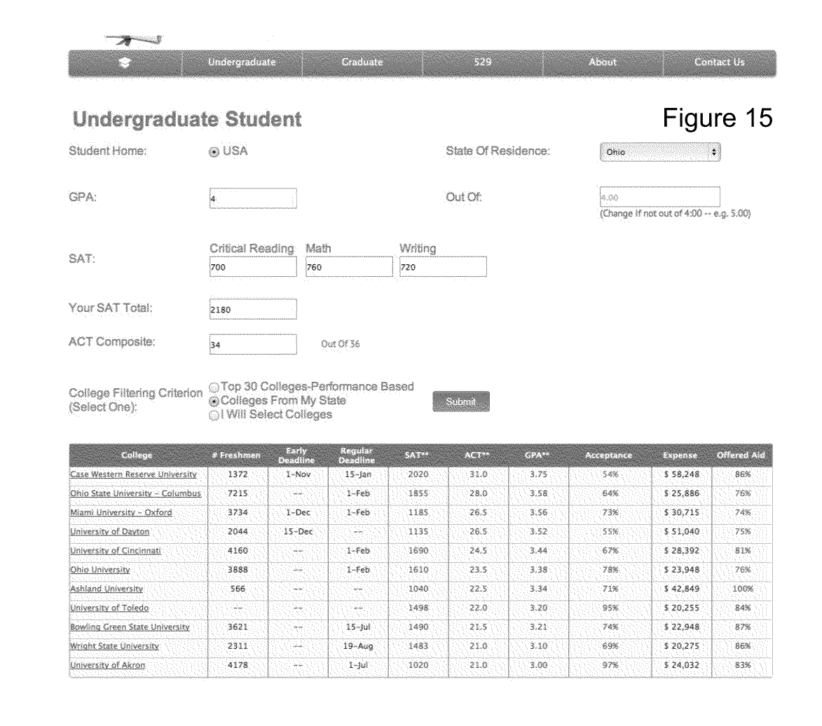

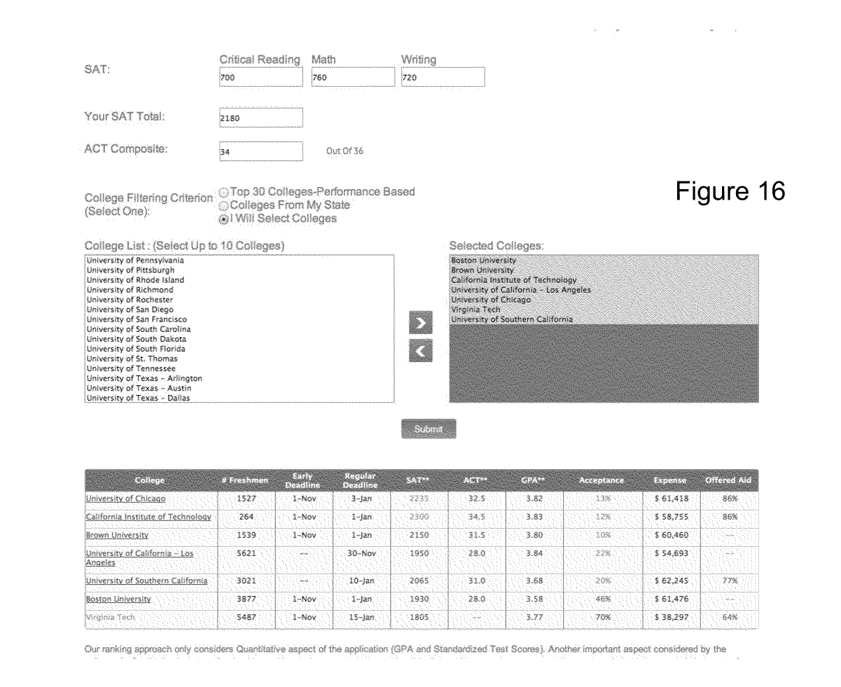

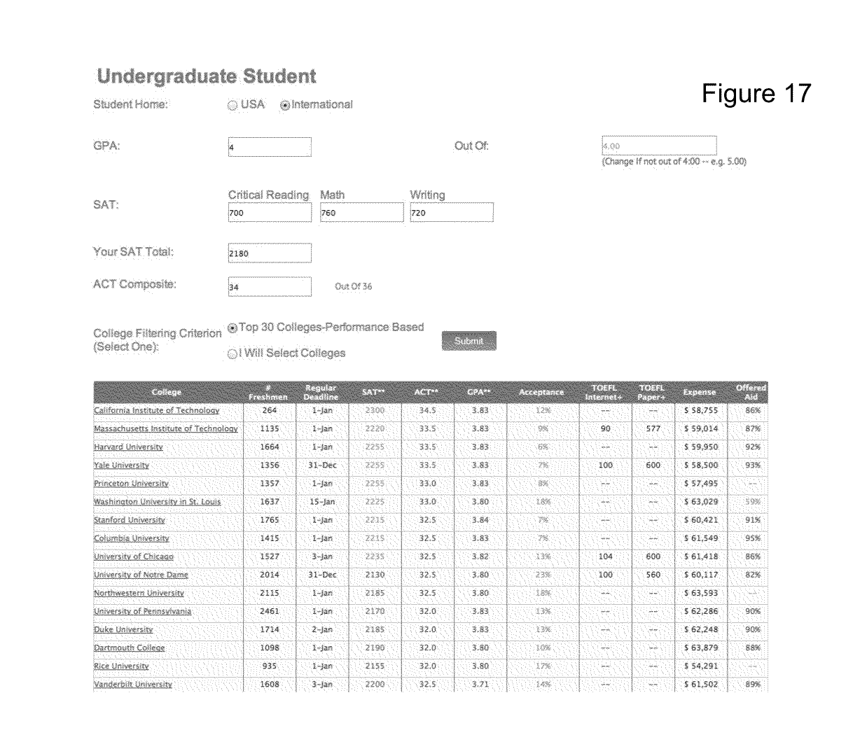

The system was applied to five real students using their publicly available academic information. This information included their names, GPAs, standardized test scores, where they applied, where they were accepted, and where they were wait-listed or denied. FIG. 10 shows two students (Allison R. and Hannah S.) with both their SAT and ACT scores, two students (Chelsea S. and Priya K.) with only SAT scores, and one student (Blake Z.) with only ACT scores. These students were chosen to reflect all three possibilities of standardized test combinations. Similarly two students (Hannah S. and Priya K.) were selected for their GPAs out of 5.00 scale. The table shows their GPA converted to 4.00 scale.

For the above students who applied to combined 22 colleges the system recommendations match well with if they were accepted or denied admission. For example system recommendations of green (the student's normalized score is either above average accepted student's score at a college or within one) show that the student was accepted. The recommendations of purple (the student's normalized score is within either two or three of an average accepted student) were all either waitlisted or accepted. The recommendations of red (accepted average student at the college with normalized score three above the student's score) shows that out of four cases, three were denied while one was accepted. The normalized academics based score approach is thus a good starting point for the student to know if there is possibility of a match (green), a stretch (purple), or a big stretch (red) with the college of his/her interest.

The approach of comparing the student's weighted average of both the GPA and the standardized test with that of the weighted average of accepted average student at a college allows college matching based on academic scores. The weights for GPA and standardized tests, which have the same weights used for the results of this work, can be modified to improve accuracy of the method as more data is collected from students. The current approach takes into consideration whether the student has taken/entered either SAT or ACT test results (and also for both). In addition, issue of some colleges considering SAT scores out of 1600 (Reading and Math) and others out 2400 (Reading, Math, and Writing) is overcome in the algorithm.

Also, it must be kept in mind that this program is solely based off of quantitative information given by students. There are other elements, which are qualitative in nature, of the college admission process involved that this program cannot take into account (essays, recommendation letters, sports, community service, work/internship/shadowing, sports, etc.) and is therefore only a first piece in the puzzle in matching the student with colleges. Once the student knows where he/she can academically fit, then they can make sure that the qualitative aspects of their application is strong.

This algorithm is made available to students via the Internet and mobile applications. This approach is also applied for graduate studies by substituting undergraduate GPAs for those of high school, and replacing ACT, and SAT standardized scores by respective standardized tests for graduate studies (e.g. Medicine—MCAT, Business—GMAT, Law—LSAT, Engineering/Sciences/Education—GRE). Moreover, this approach of academic (quantitative) based college matching for the US institutions can also be applied for other countries with appropriate substitutions for GPA, ACT, and ACT by respective country's academic grades and standardized test scores.

What is claimed is:

1. A computer based system for generating eligibility report for selecting a college for a student who is applying to a plurality of colleges, the system comprising:
a processor unit;
a computer readable medium storing instructions executable by the processor unit to perform the steps of:
receiving input from the student, comprising information associated with the student's GPA (Grade Point Average) score and one or more standardized test scores;
receiving input from the plurality of colleges, the input comprising a historically accepted students' statistical averages for GPA score and one or more standardized test scores;
calculating a normalized score for the student's GPA score by dividing the student's GPA score by a maximum possible GPA score;
calculating a normalized score for the student's at least one of one or more standardized test scores by dividing the at least one standardized test score by a maximum possible standardized test score;
calculating a normalized score for the historically accepted student's GPA score by dividing the historically accepted student's GPA by the maximum possible GPA score;
calculating a normalized score for the historically accepted student's standardized test score by dividing the historically accepted student's standardized test score by the maximum possible standardized test score;
calculating a weighted normalized score for the student by multiplying a GPA weight by the student's normalized GPA score and adding it to a multiplication of a standardized test score weight by the standardized test normalized score, where the GPA weight and the standardized test score weights add to an integer one;
calculating a weighted normalized score for the historically accepted student by multiplying the GPA score weight by the historically accepted student's normalized GPA score and adding it to a multiplication of the standardized test score weight by the historically accepted student's standardized test normalized score, where the GPA score weight and the standardized test score weight adds to an integer one;
generating a ranked list of colleges from the plurality of colleges based on the weighted normalized score of the historically accepted student;
comparing the weighted normalized score of the student with the weighted normalized score of the historically accepted student at each of the plurality of the colleges;
matching the student to the ranked list of plurality of colleges based on the weighted normalized score;
generating a report for the student who is seeking to apply to the plurality of the colleges indicating how the student's GPA (academic scores) and standardized scores compare with the historically accepted students' statistical GPA average and the historically accepted students' statistical standardized test scores average at each of the plurality of the colleges.

2. The system of claim 1 wherein the student's academic input is indicated as the weighted normalized score of the student's GPA score and the at least one of one or more standardized test scores.

3. The system of claim 1 wherein the historically accepted student's academic input is indicated as the weighted normalized score of the historically accepted student's GPA score and the at least one of one or more standardized test scores.

4. The system of claim 1 wherein academic score based matching of the student with the plurality of the colleges is based on the weighted normalized scores of GPA score and the at least one of one or more standardized test scores.

5. The system of claim 1 wherein the processing the input comprising:
classifying the GPA score and the standardized test scores identified in the input into a plurality of matching scores given by the plurality of the colleges, and
assigning the weights to the input in accordance with the weighted normalized score calculation enabling the student to know if there is possibility of a match indicated with a green color, a stretch indicated with a purple color, or a big stretch indicated by a red color with the college of his/her interest.

5. The system of claim 1 wherein the college matching report lists the plurality of colleges in a increasing order based on their weighted normalized scores with first college with a higher normalized score than a second college on the list.

7. The system of claim 1 wherein the student is pursuing undergraduate college matching.

8. The system of claim 1 wherein the student is pursuing graduate college matching.

9. The system of claim 8 wherein the student is pursuing graduate college matching for graduate medical studies.

10. The system of claim 8 wherein the student is pursuing graduate college matching for graduate legal studies.

11. The system of claim 8 wherein the student is pursuing graduate college matching for graduate business studies.

12. The system of claim 8 wherein the student is pursuing graduate college matching for graduate engineering studies.
